(19) United States
(12) Patent Application Publication
(10) Pub. No.: US 2024/0265618 A1
(43) Pub. Date: Aug. 8, 2024

(54) METHOD OF GENERATING A 3D IMAGE COMPRISING AT LEAST ONE MERGED 3D GRAPHIC ELEMENT CORRESPONDING TO AN OBJECT TO BE DETECTED

(71) Applicant: LOGYX, TOURNEFEUILLE (FR)

(72) Inventors: Christophe Arasse, TOURNEFEUILLE (FR); Sebastien Yriarte, TOURNEFEUILLE (FR)

(73) Assignee: LOGYX, TOURNEFEUILLE (FR)

(21) Appl. No.: 18/430,075

(22) Filed: Feb. 1, 2024

(30) Foreign Application Priority Data
Feb. 2, 2023 (FR) 2300972

(51) Int. Cl. G06T 15/06

(52) U.S. Cl. CPC G06T 15/06

(57) ABSTRACT

A method for generating a 3D image having at least one merged 3D graphic element corresponding to at least one object to be detected by a safety officer or by a detection algorithm using artificial intelligence. The method can include the steps of integrating at least one prepared 3D graphic element into a generated 3D image so that the at least one 3D graphic element appears in the container on the 3D image, processing the 3D image comprising the at least one integrated 3D graphic element to transform the dot meshing of the at least one 3D graphic element into voxels in the 3D image, and post-processing the processed 3D image to add artificial effects related to the material of the at least one 3D graphic element to the voxels in order to merge the at least one 3D graphic element into the 3D image.

### TECHNICAL FIELD

The present invention relates to the field of security and relates more particularly to a device that may be used for the purposes of training, maintaining competence and certification of security personnel, in particular airport personnel, or training artificial intelligence integrated into fluoroscopic imaging equipment.

### BACKGROUND

In the airport world, it is known to use security equipment comprising conveyors coupled with fluoroscopic imaging equipment making it possible to view the contents of passenger baggage on two-dimensional images. This type of security system is also used in other locations such as, for example, sensitive infrastructures or infrastructures that receive the public such as stations, prisons, stadiums, performance halls or historical monuments.

In order to train, maintain competence and test the security officers who control the images, it is known to insert objects to be detected, for example weapons or any other prohibited object, into the elements passing through the fluoroscopic imaging equipment. This method is tedious and time-consuming because the objects must be inserted into the items to be controlled (baggage, clothing, etc.), the officers trained or tested, and then the objects must be retrieved.

Another known solution is to modify the images generated by the fluoroscopic imaging equipment before they are viewed by the security officer. This modification consists in scanning the objects to be detected beforehand and then overlaying the images of the scanned objects on the 2D images of the elements to be controlled passing through the fluoroscopic imaging equipment. This method may also be tedious and time-consuming. In addition, the credibility of objects integrated into 2D images may be questionable, which makes them easy for officers to detect and has a disadvantage in terms of training

In particular, in order to train the detection algorithms integrated into the fluoroscopic imaging equipment or to verify the proper operation and maintenance of the performance of this equipment, it is also known to use these two solutions.

The recent arrival of fluoroscopic imaging equipment making it possible to view the contents of luggage in 3D, enabling better viewing of luggage and the objects it contains, as well as the growing development of artificial intelligence in the field of security, create a need for training, maintaining competence, certification and testing of security personnel with this new technology, but it also creates a need for training, known as machine learning, of the artificial intelligence integrated into fluoroscopic imaging equipment.

To meet these needs, a first approach is to insert prohibited objects into the suitcases and bags to be controlled so that they appear in the 3D images. However, as with the 2D method, this method may be tedious and time-consuming.

A second solution consists in transforming the 3D images into 2D images, inserting the objects to be detected in 2D by overlay in the 2D images before viewing by the officer, as previously. Again, this method may be tedious and time-consuming.

It would therefore be advantageous to propose a simple, reliable and effective solution that makes it possible to at least partially remedy these disadvantages.

### SUMMARY

The aim of the invention is to provide a simple, reliable, efficient and fast solution for training, maintaining competence, certifying and testing security officers.

To this end, the first aim of the invention is a method for generating a 3D image comprising at least one merged 3D graphic element corresponding to at least one object to be detected by a security officer or by a detection algorithm using artificial intelligence, said method comprising the steps of:
preparing at least one 3D graphic element to be detected, said at least one 3D graphic element being characterized by a dot meshing and at least one material,
generating a 3D image in voxels representing at least one container to be controlled by the security officer or by the detection algorithm using artificial intelligence,
integrating the at least one prepared 3D graphic element into the generated 3D image so that said at least one 3D graphic element appears in the container on the 3D image,
processing the 3D image comprising the at least one integrated 3D graphic element to transform the dot meshing of the at least one 3D graphic element into voxels in the 3D image,
post-processing the processed 3D image to add artificial effects related to the material of the at least one 3D graphic element to the voxels in order to merge said at least one 3D graphic element into the 3D image.

The term “voxel” refers to a volume of pixels in three dimensions.

The term “dot meshing” means a vector representation in meshes of dots.

The container to be controlled may be, for example, a suitcase, a bag, a parcel, etc.

The method according to the invention makes it possible to integrate one or more 3D objects into a 3D image by performing a virtual print. In particular, the transformation of the meshing into voxels of each 3D graphic element integrated into the 3D image makes it possible to define the contours and the interior of said 3D graphic element(s). By integrating virtual 3D objects into a 3D image further makes it possible to avoid handling hazardous objects or hazardous materials, thus increasing work safety. Integrating virtual 3D objects into a 3D image also makes it possible to integrate objects, for example based on their technical specification, which are not yet available or which are difficult or impossible to access due to applicable legislation. The use of a 3D mesh allows you to use many variants of an object (size, materials, etc.), to accessorize it (e.g. empty gun, loaded, with viewfinder, etc.) and above all to modify it a posteriori via a 3D editor, for example to make it evolve without having a scanner, which is not the case with an acquisition (3D scan) of the physical object. Another advantage of using synthetic meshed 3D threats is that the merging process relies on vector data and therefore makes it mathematically adaptable, unlike a physical acquisition. By leveraging vector data, the system can merge a threat library at any voxel resolution. The invention thus enables compatibility with future machines exploiting higher resolutions because it can merge threats at a submillimeter scale. Integrating virtual 3D objects into a 3D image also makes it possible to avoid the use of polluting objects. Finally, the method according to the invention may be implemented in parallel with several machines, for example via a communication network, which proves to be simpler and involves less maintenance and costs than with a plurality of real 3D fluoroscopic imaging equipment used in parallel. In addition, the method according to the invention makes it possible to simulate several different machines in parallel.

Advantageously, the processing of the 3D image comprising the at least one integrated 3D graphic element comprises a 3D digital scan of the elements of the 3D image.

Preferably, the scan comprises sending a plurality of digital rays on the elements of the 3D image in order to define for each one their contour and position. Such a scan may, for example, be performed by ray tracing algorithms or ray marching algorithms. Such a scan, similar to a 3D printing technique, makes it possible to create, in particular, the thickness traces of the elements appearing on the 3D image.

In one embodiment, the generation of the 3D image is performed from at least one real container, for example via real 3D fluoroscopic imaging equipment.

In another embodiment, the generation of the 3D image is performed virtually, for example from a 3D image generator that will generate a 3D image representing the at least one container, possibly comprising objects.

In one embodiment, the preparation comprises generating at least one new 3D graphical element.

In another embodiment, the preparation comprises retrieving at least one existing 3D graphical element, for example from a database.

Advantageously, the preparation comprises a step of identifying and assigning a material to each part of each 3D graphic element.

More advantageously, the preparation comprises a step of assigning a density to the material of the at least one 3D graphic element, said density enabling the nature of the material present in a voxel to be determined during processing of the 3D image.

More advantageously, the post-processing of the 3D image comprises the creation of a volume of raw material (i.e. without artificial effects), creating a volume of artificial metallic effects, creating a volume of Compton effects and merging these three volumes.

According to one aspect of the invention, the method comprises a step of associating metadata of the at least one 3D graphic element to an area of the 3D image comprising at least in part the at least one 3D graphic element.

According to one aspect of the invention, the method comprises a step of selecting, by the safety officer or by the detection algorithm using artificial intelligence, an area of the post-processed 3D image.

According to one aspect of the invention, the method comprises a step of detecting the at least one 3D graphic element when the area of the selected post-processed 3D image corresponds to the area associated with the metadata.

The invention also relates to a computer program product wherein a set of program code instructions which, when run by one or more processors, configure the processor(s) to implement a method as presented hereinabove.

The invention also relates to a module for generating a 3D image comprising at least one 3D graphic element corresponding to an object to be detected by a security officer or by a detection algorithm using artificial intelligence, said module being configured to:
prepare at least one 3D graphic element to be detected, said at least one 3D graphic element being characterized by a dot meshing and at least one material,
generate a 3D image in voxels representing at least one container to be controlled by the security officer or by the detection algorithm using artificial intelligence,
integrate at least one prepared 3D graphic element into the generated 3D image so that said at least one 3D graphic element appears in the container in the 3D image,
process the 3D image comprising the at least one integrated 3D graphic element to transform the dot meshing of the at least one 3D graphic element into voxels in the 3D image,
post-process the processed 3D image to add material-related effects in order to finalize its merger into the 3D image.

Preferably, the generation module is configured to, when processing the 3D image comprising the at least one integrated 3D graphic element, perform a digital scan of the elements of the 3D image.

Preferably, the generation module is configured to, during a scan, send a plurality of digital rays on the elements of the 3D image in order to define for each one their contour and position, for example by “ray tracing” or “ray marching”.

Advantageously, the generation module is configured to, during preparation, identify and assign a material to each part of each 3D graphic element.

Advantageously, the generation module is configured to, during preparation, assign a density to the material of the at least one 3D object, said density allowing to determine the nature of the material present in a voxel during processing of the 3D image.

In one embodiment, the generation module is configured to generate at least one 3D image from at least one real container, for example via real 3D fluoroscopic imaging equipment.

Alternatively or in addition, the generation module is configured to generate at least one 3D image virtually, for example from a 3D image generator.

Advantageously, the generation module is configured to associate metadata of the at least one 3D graphic element to an area of the 3D image comprising at least in part the at least one 3D graphic element.

More advantageously, the generation module is configured to detect the at least one 3D graphic element when the area of the selected post-processed 3D image corresponds to the area associated with the metadata.

In one embodiment, the generation module is configured to, when preparing the at least one 3D object, generate at least one new 3D object.

Alternatively or in addition, the generation module is configured to retrieve at least one existing 3D object when preparing the at least one 3D object.

Preferably, the generation module is configured to, during post-processing of the 3D image, create a volume of raw material, create a volume of artificial metallic effects, create a volume of Compton effects, and merge these three volumes.

The invention also relates to computer equipment comprising a generation module such as presented hereinabove.

The computer equipment may be user equipment such as, for example, a computer, tablet, smartphone, virtual and/or augmented reality equipment, etc.

The computer equipment may be a server.

In one embodiment, the computer equipment is configured to allow selection, by the security officer or by the detection algorithm using artificial intelligence, of an area of the post-processed 3D image.

The invention also relates to a system comprising server-type computer equipment as presented above and at least one user equipment configured to display a post-processed 3D image received from the server and to enable a user of said user equipment to select or point to an area of the post-processed 3D image.

### BRIEF DESCRIPTION OF THE DRAWINGS

Further characteristics and advantages of the invention will further appear upon reading the description that follows. This is purely illustrative and should be read in conjunction with the appended drawings in which:

FIG. 1 schematically shows an embodiment of the computer equipment according to the invention.

FIG. 2 schematically shows an embodiment of the system according to the invention.

FIG. 3 schematically shows an embodiment of the method according to the invention.

### DETAILED DESCRIPTION

The computer equipment according to the invention may be implemented autonomously or in a communication system in order to enable a security officer or a detection algorithm using artificial intelligence to detect prohibited objects in 3D images.

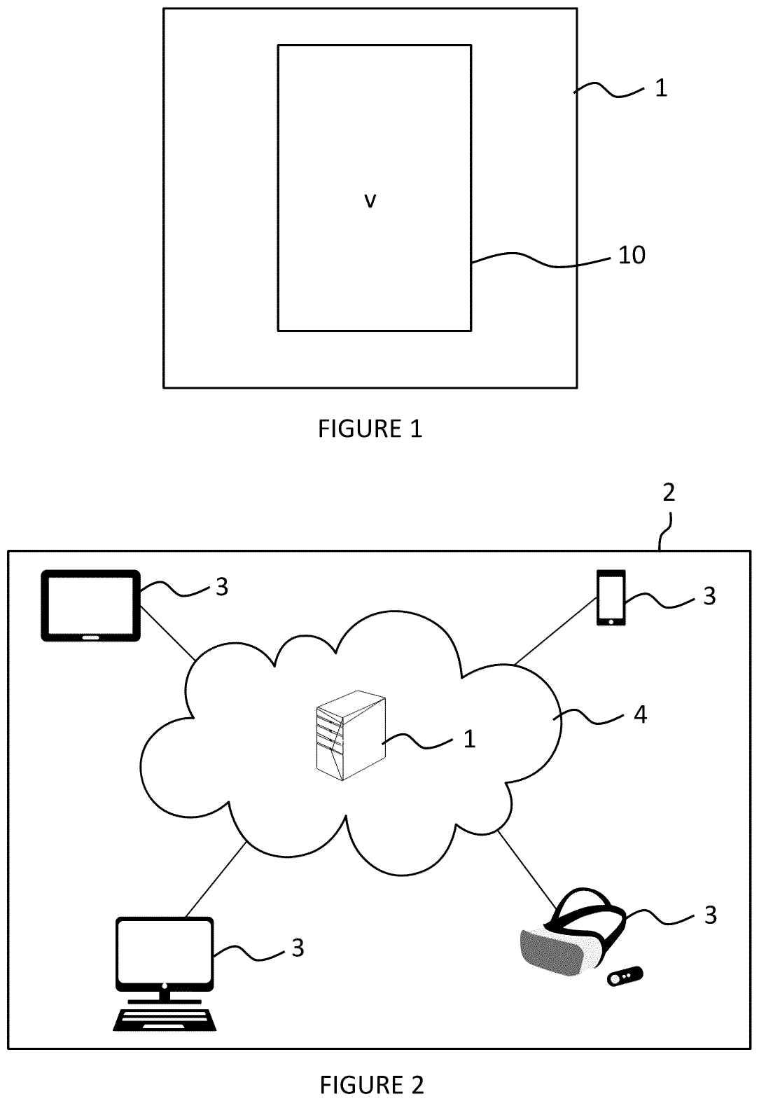

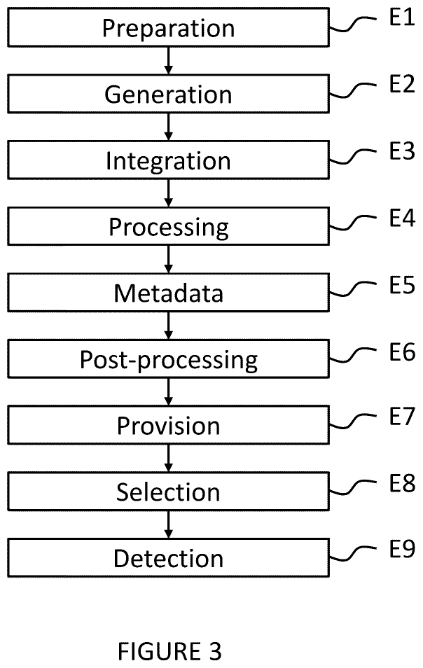

FIG. 1 shows one embodiment of computer equipment 1 according to the invention. The computer equipment 1 may operate autonomously by being, for example, of the computer, tablet or smartphone type or any other suitable equipment or by being integrated into a broader system of the communication network type.

FIG. 2 shows one embodiment of a communication system 2 according to the invention. The system 2 comprises computer equipment 1 of the server type and user equipment 3 of the computer, tablet, smartphone or virtual and/or augmented reality equipment type, connected to said computer equipment 1 via a communication network 4.

### Computer Equipment 1

In reference to FIG. 1, the computer equipment 1 comprises a generation module 10 according to the invention. In the case of computer-type computer equipment 1, the computer equipment 1 comprises a screen, a keyboard and a mouse to allow the security officer to interact with the 3D image appearing on said screen, in particular by pointing to a suspicious object in said 3D image. In the case of computer equipment 1 of the smartphone or tablet type, the computer equipment 1 comprises a touch screen allowing entry, pointing and selection to allow the security officer to interact with the 3D image appearing on said touch screen, in particular to attempt to detect a suspicious object in said 3D image. In the case of computer equipment 1 of the virtual reality or augmented reality equipment type, the computer equipment 1 advantageously comprises a hand tracking system, an eye tracking system, neural pulse sensors or a controller allowing, pointing and selecting to allow the security officer to interact with the 3D image appearing on said touch screen, in particular to attempt to detect a suspicious object in a 3D universe exploiting said 3D image.

### Generation Module 10

The generation module 10 makes it possible to generate at least one 3D image comprising at least one 3D graphic element corresponding to an object to be detected by a security officer or by a detection algorithm using artificial intelligence. The generation 10 module may at least partially take the form of an application or computer program implemented by the computer equipment 1.

### Preparation

The generation module 10 is configured to prepare at least one 3D graphic element to be detected, said at least one 3D graphic element being characterized by a dot meshing and at least one material.

The generation module 10 may be configured to, when preparing the at least one 3D graphic element, generate at least one new 3D graphic element.

Alternatively or in addition, the generation module 10 may be configured to, when preparing the at least one 3D graphic element, retrieve at least one existing 3D graphic element.

The generation module 10 is configured to, during preparation, assign a density to the material of the at least one 3D graphic element, said density allowing to determine the nature of the material present in a voxel during processing of the 3D image.

More precisely, assigning a material and a density allows calculating an average density per voxel as a function of the density of the materials represented on said voxel (in kg/m3) and characterizing the behavior of a material during scanning

On the latter point, for example, a solid will generate a full volume, a metal will induce metal artifacts, a liquid will be generated in the volume identified by respecting gravity with insertion of waves simulating the effect of the conveyor belt, powder will be generated in the volume by respecting gravity and a settling/stacking logic. For a deformable material, a Boolean operation may be performed by prioritizing the other materials present in the same voxel. For a soft material, for example a garment, a deformation of the meshing may be achieved, for example during a shaking phase (described hereinafter).

### 3D Image

The generation module 10 is configured to generate a 3D image in voxels representing at least one container to be controlled by the security officer or by the detection algorithm using artificial intelligence.

The generation module 10 is configured to generate the 3D image from at least one real container, for example via real 3D fluoroscopic imaging equipment.

Alternatively or in addition, the generation module 10 may be configured to generate the 3D image virtually, for example from a 3D image generator.

### Adding the Meshed 3D Graphic Element

The generation module 10 may be configured to integrate at least one prepared 3D graphic element into the generated 3D image so that said at least one 3D graphic element appears in the container on the 3D image.

### Processing

The generation module 10 is configured to process the 3D image comprising the at least one integrated 3D graphic element to transform the dot meshing of the at least one 3D graphic element into voxels in the 3D image.

The generation module 10 is configured to, when processing the 3D image comprising the at least one integrated 3D graphic element, perform a digital scan of the elements of the 3D image.

The generation module 10 is configured to, during a scan, send a plurality of digital rays on the elements of the 3D image in order to define their contour and position for each. Preferably, a “ray tracing” or “ray marching” method is used.

The generation module 10 is configured to associate metadata of the at least one 3D graphic element to an area of the 3D image comprising at least in part the at least one 3D graphic element.

Preferably, the metadata collected are of geometric and functional orders. The geometric data may be linked to a bounding box defined by its center and size in the luggage reference standard, or it may be a volume, a mass, etc. Functional data may be a name, a type of threat to be detected by the officer or the artificial intelligence detection algorithm, a role in a compound threat, a technical specificity (e.g. electrical voltage), etc.

Metadata may also comprise information from the container that may be interpreted as alarms. Container alarm data may be collected during the container import phase. The metadata is associated with each volume and grouped together when merging the volumes as is described hereinafter.

### Post-Treatment

The generation module 10 is configured to post-process the processed 3D image to add material-related effects to merge it into the 3D image.

The generation module 10 is configured to, during post-processing of the 3D image, create a volume of raw material, create a volume of artificial metallic effects, create a volume of Compton effects, and merge these three volumes.

The generation module 10 is configured to add artificial effects related to the container material and the material of each object during post-processing of the 3D image.

### Use

The generation module 10 is configured to detect the at least one 3D graphic element when the area of the selected post-processed 3D image corresponds to the area associated with the metadata. To avoid a search step, which would be performed in real time by real 3D fluoroscopic imaging equipment, the generation module 10 is configured to directly exploit the coordinate, bounding box and volume information already prepared and provided in the metadata.

Each generation module 10 or computer equipment 1 comprises a processor capable of implementing a set of instructions enabling these functions to be performed.

### Example of Implementation

In a step E1, the generation module 10 prepares one or more 3D graphic elements to be detected. Each 3D graphic element is characterized by its dot meshing and its material(s).

The preparation comprises generating at least one new 3D graphic element or retrieving at least one existing 3D graphic element.

In the following example, for reasons of clarity, a single 3D graphic element is prepared and corresponds to a knife with a metal blade and a handle made of another material, e.g. wood.

Advantageously, the method may comprise a step of scaling the at least one new 3D graphical element so that all 3D objects manipulated in the method are at the same reference scale, for example the meter.

Preferably, the method comprises a retopology step allowing to simplify the topology of a meshing to make it cleaner and easier to use and manifold.

Preferably, the preparation comprises a step of identifying and assigning a material to each part of each 3D graphic element. Thus, in the present example, the knife handle is associated with the wood material (density of about 690 kg/m³ for walnut for example) and the knife blade is associated with the steel material (density of about 7,800 kg/m³). The association of a material to a meshing area may be carried out in the preparation phase via a graphical interface (e.g. by pointing or selecting an area) or it may be integrated into the computer code, in particular for dynamically generated 3D objects (e.g. cables or liquids).

More preferably, the preparation comprises a step of assigning a material density to each material of each 3D graphic element, said density enabling the nature of the material present in each voxel of the 3D image to be determined when processing said 3D image. For example, water has a density of 1,000 kg/m³.

In a step E2, the generation module 10 generates a 3D image in voxels representing at least one container to be controlled by the security officer or by the detection algorithm based on artificial intelligence, for example a suitcase or a bag. In the following example, for reasons of clarity, the container is unique and a suitcase. The generation of the 3D image may be performed from a real suitcase, for example by passing it into real 3D fluoroscopic imaging equipment, or virtually, for example from a 3D image generator, in a manner known per se. In the 3D image, the suitcase may comprise objects placed inside the suitcase, such as clothing, documents, a camera, shoes, pens, etc. These objects may be actually placed in the suitcase and thus passed through the 3D fluoroscopic imaging equipment or added to the 3D image by a 3D image generator. When the objects are placed in the suitcase by a 3D image generator, the method may comprise a shaking step for dispersing and distributing the objects in the suitcase, especially when they are simply placed vertically in the suitcase when being integrated by the 3D image generator.

In a step E3, the generation module 10 integrates the prepared knife into the generated 3D image so that said knife appears as being placed inside the suitcase on the 3D image. At this stage, the knife is still a meshed 3D graphic element.

In a step E4, the generation module 10 performs a processing of the 3D image comprising the integrated 3D representation of the knife in order to transform the dot meshing of the 3D representation of the knife into voxels in the 3D image of the suitcase. In other words, the knife and suitcase are assembled in the 3D image. This transformation makes it possible in particular to define the contours and thickness traces of the knife integrated into the 3D image and other objects. In this embodiment, the processing of the 3D image comprising the integrated knife comprises a digital scan of the elements of the 3D image. For example, this scan may comprise sending a plurality of digital rays on the elements of the 3D image in order to define for each one their contour and position. For example, a known method of “ray marching” may be used. In general, the method according to the invention may be used with a digital scan on at least one axis, for example on three axes (the three dimensions), back and forth in order to define the contours and thicknesses of the objects appearing on the 3D image.

In a step ES, metadata relating to the knife, for example its nature as an object, its position in the 3D image and its volume in the 3D image, are associated with an area of the processed 3D image. This metadata may have been generated during the preparation phase: for example, dynamic behaviors may have been assigned by dragging and dropping on objects. For example, a knife may be associated with a type of sharp threat, a battery may be associated with its electrical voltage, etc.

In a step E6, the generation module 10 performs post-processing of the processed 3D image to add artificial effects related to the material of the at least one 3D graphic element in order to merge said at least one 3D graphic element into the 3D image. Artificial effects, or artifacts, are effects such as those visible on 3D images generated by real 3D fluoroscopic imaging equipment.

It should be noted that step ES may have been performed before step E4 or after step E6 or in parallel with step E4 or step E6.

In this preferred example, post-processing of the 3D image comprises creating a volume of raw material, creating a volume of artificial metallic effects, creating a volume of Compton effects, and merging these three volumes. The volume of raw material, the volume of artificial metallic effects and the volume of Compton effects correspond to the volume of material represented on the 3D image at the same scale.

The raw material volume corresponds to a 3D volume comprising the generated 3D objects to be inserted. In particular, to define the volume of raw material, the points of impact of the digital rays on the objects are taken into account to calculate the ratio of material present in each voxel of the processed 3D image and, preferably, the density of each voxel, in particular when said voxel comprises several materials. In the latter case, the voxel density is calculated as the sum of the products of the density of each material by the volume occupied by said material in the voxel.

More precisely, the establishment of the gross volume preferably follows the following algorithm: for each voxel, the traces of materials that make it up are detected, then, depending on the behavior of the material(s) [deformable, powder, liquid, solid, etc.], their density values kg/m3 and the angle of incidence of the digital scanning radius on the material, their participation ratio in the voxel is established and this value is entered in the gross volume.

The notion of “gross” volume reflects a “perfect” scan environment without any defects. The defects that may appear in a 3D scan in a real machine context may in particular be an element with a non-uniform density, an element with a manufacturing defect or wear or in a degraded condition, 3D fluoroscopic imaging equipment that emits artifacts due to poor calibration or wear, or poorly performing 3D fluoroscopic imaging equipment.

The creation of the volume of artificial metallic effects corresponds to showing on the 3D image, in particular on the knife, deformations as they appear on images of real 3D fluoroscopic imaging equipment made on a real suitcase containing real metallic objects. Creating the volume of artificial metal effects comprises analyzing the presence of metal in the processed 3D image, analyzing the presence of metal in the added 3D graphics elements (knife), applying artificial effects generated by the suitcase to the knife, and applying artificial effects generated by the knife to the suitcase and its other objects.

The creation of the volume of Compton effects, known per se, involves the creation of a volume comprising artificial effects corresponding to elastic diffusion when considering a free but inelastic electron for a bonded electron.

These three volumes are merged by overlay and then merged with the suitcase to blend the knife into the 3D image of the suitcase as if it were a real part of a 3D scanned suitcase.

A post-processing of metal artifacts is performed on all the suitcase and the objects it contains in order to show the effects related to the metal objects in their final configuration in the suitcase.

Next, the post-processed 3D image is made available to a security officer or a detection algorithm using artificial intelligence in a step E7, either directly on the computer equipment 1 in the case for example of a computer or a tablet or a smartphone or a virtual or augmented reality equipment or, as shown in FIG. 2, via a communication network 4 and a client installed on user equipment (computers, tablet and smartphone 3 in FIG. 2) remote in the case where the generation module 10 is implemented on a server.

The security officer or detection algorithm using artificial intelligence then selects or points, in step E8, to an area of the post-processed 3D image. If the selected area corresponds to the knife, for example by checking the metadata on the knife position in the post-processed 3D image, then the knife detection is performed and confirmed in step E9. The security officer presentation software is content agnostic and uses the metadata file like a map.

By enabling the full integration of a knife-type 3D object into a 3D image, the invention makes it possible to perform effective training of security officers and/or also to validate the reliability and performance of an artificial intelligence-based detection algorithm. In particular, many 3D images representing different containers comprising different objects, prohibited or not, may be generated with the method according to the invention and used in large numbers to train and test the security officers. The method and the generation module according to the invention may also be used with real 3D fluoroscopic imaging equipment to detect threats in real time and thereby increase security, in particular at airports.

1. A method for generating a 3D image comprising at least one merged 3D graphic element corresponding to at least one object to be detected by a security officer or by a detection algorithm using artificial intelligence, said method comprising the steps of:
preparing at least one 3D graphic element to be detected, said at least one 3D graphic element being characterized by a dot meshing and at least one material,
generating of a 3D image in voxels representing at least one container to be controlled by the security officer or by the detection algorithm using artificial intelligence,
integrating the at least one prepared 3D graphic element into the generated 3D image so that said at least one 3D graphic element appears in the container on the 3D image,
processing the 3D image comprising the at least one integrated 3D graphic element to transform the dot meshing of the at least one 3D graphic element into voxels in the 3D image,
post-processing of the processed 3D image to add artificial effects related to the material of the at least one 3D graphic element to the voxels in order to merge said at least one 3D graphic element into the 3D image.

2. The method according to claim 1, wherein the processing of the 3D image comprising the at least one integrated 3D graphic element comprises a 3D digital scan of the elements of the 3D image.

3. The method according to claim 1, wherein the scanning comprises sending a plurality of digital rays on the elements of the 3D image in order to define for each one their contour and position.

4. The method according to claim 1, wherein the generation of a 3D image sequence is performed from at least one real container, for example via real 3D fluoroscopic imaging equipment, or virtually, for example from a 3D image generator.

5. The method according to claim 1, said method further comprising a step of associating metadata of the at least one 3D graphic element to an area of the 3D image comprising at least in part the at least one 3D graphic element, a step of selecting, by the security officer or by the detection algorithm using artificial intelligence, a post-processed area of the 3D image, and a step of detecting the at least one 3D graphic element when the area of the selected post-processed 3D image corresponds to the area associated with the metadata.

6. The method according to claim 1, wherein the preparation comprises generating at least one new 3D graphic element or retrieving at least one existing 3D graphic element.

7. The method according to claim 1, wherein the post-processing of the 3D image comprises creating a volume of raw material, creating a volume of artificial metallic effects, creating a volume of Compton effects, and merging these three volumes.

8. A computer program product characterized in that it comprises a set of program code instructions which, when run by one or more processors, configure the processor(s) to implement the method according to claim 1.

9. A generation module of a 3D image comprising at least one 3D graphic element corresponding to an object to be detected by a security officer or by a detection algorithm using artificial intelligence, said module being configured to:
prepare at least one 3D graphic element to be detected, said at least one 3D graphic element being characterized by a dot meshing and at least one material,
generate a 3D image in voxels representing at least one container to be controlled by the security officer or by the detection algorithm using artificial intelligence,
integrate at least one prepared 3D graphic element into the generated 3D image so that said at least one 3D graphic element appears in the container in the 3D image,
process the 3D image comprising the at least one integrated 3D graphic element to transform the dot meshing of the at least one 3D graphic element into voxels in the 3D image,
post-process the processed 3D image to add material-related effects in order to finalize its merger into the 3D image.

10. A computer equipment comprising a generation module according to claim 9.
